(19) United States
(12) Patent Application Publication
(10) Pub. No.: US 2002/0063504 A1
(43) Pub. Date: May 30, 2002

(54) Spark plug designed to provide high durability and productivity

(76) Inventor: Tsunenobu Hori, Kariya-shi (JP)

Correspondence Address: LAW OFFICE OF DAVID G POSZ, 2000 L STREET, N.W., SUITE 200, WASHINGTON, DC, 20036, US

(21) Appl. No.: 09/988,688

(22) Filed: Nov. 20, 2001

(30) Foreign Application Priority Data
Nov. 24, 2000 (JP) 2000-358187
Sep. 6, 2001 (JP) 2001-270823

(51) Int. Cl. H01T 13/32

(52) U.S. Cl. 313/141

(57) ABSTRACT

An improved structure of a spark plug is provided for improving the productivity and durability thereof. The spark plug has a ground electrode opposed to a center electrode to define a spark gap therebetween. The ground electrode is made of a noble metal such as an Ir alloy for increasing the heat and wear resistance and is joined directly to a metal shell of the spark plug by laser or arc welding.

### BACKGROUND OF THE INVENTION

1. Technical Field of the Invention

The present invention relates generally to a spark plug which may be employed in automotive vehicles, gas pumps and cogeneration systems, and more particularly to a spark plug which is so designed as to provide high durability and productivity.

2. Background Art

Typical spark plugs have a ground electrode made of a Ni (Nickel) alloy for improving heat and wear resistances. The ground electrode is installed at one end thereof in a metal shell by means of the resistance welding and has a chip made of a noble metal such as Ir (Iridium) or Pt (Platinum) welded in a surface of the ground electrode opposed to a center electrode.

The above type of spark plugs, however, encounter the drawback in that the ground electrode is subjected to pressure during the resistance welding, thus resulting in a variation in length of an end portion of the ground electrode embedded in the metal shell, which leads to a variation in an air gap (also called a spark gap) between the ground electrode and the center electrode. This requires gap adjustment after the ground electrode is welded to the metal shell, thus resulting in a decrease in productivity.

Further, the above type of spark plugs require two welds: one being between the ground electrode and the metal shell and the other being between the ground electrode and the noble metal chip, thus resulting in a more decreased productivity.

We also have found the following additional drawback of the above type of spark plugs when used in, for example, an engine of a cogeneration system in which the engine is subjected to high combustion pressures and high thermal loads. Specifically, a welded portion of a base member (i.e., the ground electrode) with the noble metal chip is subjected to intense heat, thereby resulting in abnormal oxidation of a grain boundary thereof. This causes damage to the welded portion of the base member, which may result in dislodgement of the noble metal chip therefrom and an increase in air gap.

In order to avoid the above problem, we have made a spark plug sample, as shown in FIGS. 14(a) to 14(c). The spark plug sample consists of a metal shell 10 made of an Fe-base material (e.g., carbon steel), a center electrode 30 installed in the metal shell 10 in isolation therefrom, and a ground electrode 40. The ground electrode 40 consists of a base member 41 made of an Ni or Fe-base material and an Ir alloy chip 42 welded in the base member 41.

The base member 41 is secured at one end thereof on the metal shell 10 and holds the Ir alloy chip 42 in the other end thereof. The Ir alloy chip 42 extends horizontally, as viewed in FIG. 14(a), over the top 31 of the center electrode 30 and defines the air gap 50 between the top 43 of the Ir alloy chip 42 and the top 31 of the center electrode 30.

The top of the ground electrode 40 which is usually subjected to the highest temperature is, as described above, made of the Ir alloy chip having an excellent heat resistance, thereby avoiding the abnormal oxidation of a grain boundary of the base member 41, which contributes to the avoidance of an undesirable rise in temperature of a joint of the Ir alloy chip 42 and the base member 41. Fused portions 45 in which materials of the Ir alloy chip 42 and the base member 41 are melted together do not exist on or near a vertical line passing through the air gap 50, thereby avoiding the dislodgement of the Ir alloy chip 42 arising from spark-caused wear of the fused portions 45.

In recent years, increases in output power and combustion efficiency of the engines are required, which will result in increases in thermal load on and vibration of the engines. Therefore, the spark plug sample, as described above, uses as a discharging member the Ir alloy chip 42 which is excellent in wear resistance, but when the whole of the ground electrode 40 including the base member 41 is exposed to higher temperatures, it will cause the wear of the Ir alloy chip 42 to be promoted.

When subjected to vibration, thermal stress, and/or oxidation of a grain boundary, the joint of the Ir alloy chip 42 and the base member 41 is broken easily. In the worst case, the Ir alloy chip 42 drops from the base member 41. It is, therefore, difficult for the spark plug sample to satisfy the need for an increased service life.

The central electrode 30 has the top 31 made of an Ir alloy chip 31a. A weld between the Ir alloy chip 31a and a body 32 of the central electrode 30 is surrounded by an insulator 20 and thus is hardly subjected to the discharge-caused wear as taken place in the ground electrode 40.

As apparent from the above discussion, with increasing of required engine power and combustion efficiency, there is an increasing need for improving the durability of a ground electrode of a spark plug further to reduce the damage and wear of the ground electrode, thereby increasing a lifespan of the spark plug.

### SUMMARY OF THE INVENTION

It is therefore a principal object of the invention to avoid the disadvantages of the prior art.

It is another object of the invention to provide a spark plug designed to provide higher durability and productivity.

According to one aspect of the invention, there is provided a spark plug which may be employed in automotive vehicles, gas pumps and cogeneration systems and which is so designed as to provide higher durability and productivity. The spark plug comprises: (a) a metal shell; (b) a center electrode retained in the metal shell to be insulated from the metal shell; and (c) a ground electrode opposed to the center electrode to define a spark gap between the ground electrode and the center electrode. The ground electrode is joined to the metal shell by one of laser welding and arc welding.

In the preferred mode of the invention, the whole of the ground electrode is made of an Iridium alloy and welded at an end thereof directly to the metal shell.

The depth of a weld between the ground electrode and the metal shell lies within a range of 0.3 mm to 1.5 mm.

The metal shell may be made of an Fe-base alloy containing at least one of 0.15% by weight or less of S, 0.35% by weight or less of Si, 0.25% by weight or less of C, 1.5% by weight or less of Mn, and 0.1% by weight or less of P.

The ground electrode may be made of an alloy containing a main component of 50 Wt % or more of Pt and an additive of at least one of Rh, Ir, Os, Ni, W, Pd, and Ru.

The ground electrode may alternatively be made of an alloy containing a main component of 50 Wt % or more of Ir and an additive of at least one of Rh, Pt, Os, Ni, W, Pd, and Ru.

According to the second embodiment of the invention, there is provided a spark plug comprising: (a) a metal shell; (b) a center electrode retained in the metal shell to be insulated from the metal shell; and (c) a ground electrode opposed to the center electrode to define a spark gap between the ground electrode and the center electrode. The ground electrode is all made of an Iridium alloy and joined directly to the metal shell.

The ground electrode is joined to the metal shell by laser welding.

The depth of a weld between the ground electrode and the metal shell lies within a range of 0.3 mm to 1.5 mm.

The metal shell may be made of an Fe-base alloy containing one of 0.15% by weight or less of S, 0.35% by weight or less of Si, 0.25% by weight or less of C, 1.5% by weight or less of Mn, and 0.1% by weight or less of P.

The metal shell may alternatively be made of an Fe-base alloy containing some or all of 0.15% by weight or less of S, 0.35% by weight or less of Si, 0.25% by weight or less of C, 1.5% by weight or less of Mn, and 0.1% by weight or less of P.

The ground electrode may be made of an alloy containing a main component of 50 Wt % or more of Ir and an additive of at least one of Rh, Pt, Os, Ni, W, Pd, and Ru.

According to the third aspect of the invention, there is provided a method of producing a spark plug comprising the step of: (a) preparing a metal shell; (b) installing a center electrode in the metal shell to be insulated from the metal shell; (c) placing a ground electrode so as to be opposed to the center electrode through a spacer having a thickness substantially equal to a desired spark gap to be defined between the ground electrode and the center electrode; and (d) joining the ground electrode to the metal shell by one of laser welding and arc welding.

### BRIEF DESPCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially sectional view which shows a spark plug according to the first embodiment of the invention;

FIG. 2(a) is a partially enlarged sectional view of a portion, as expressed by a circle B in FIG. 1, which shows a joint of a ground electrode to a metal shell by means of laser welding in the first embodiment of the invention;

FIG. 2(b) is a plan view of FIG. 2(a);

FIG. 2(c) is a sectional view taken along the line C-C in FIG. 2(b);

FIG. 3(a) is a partially enlarged sectional view which shows a joint of a ground electrode to a metal shell by means of arc welding in the first embodiment of the invention;

FIG. 3(b) is a plan view of FIG. 3(a);

FIG. 3(c) is a sectional view taken along the line D-D in FIG. 3(b);

FIG. 4 is a graph which shows relations between a durability test time and an increase in spark gap of a spark plug of the first embodiment and a comparative spark plug shown in FIGS. 14(a) to 14(c);

FIG. 5 is a graph which shows relations between a durability test time and joint strength of a spark plug with a laser welded ground electrode, a spark plug with an arc welded ground electrode, and a comparative spark plug shown in FIGS. 14(a) to 14(c);

FIG. 6 is a graph which represents a relation between an element content (Wt %) and a joint strength (N) in spark plug samples;

FIG. 7(a) is a partially enlarged sectional view which shows a spark plug sample for evaluating the melt depth of a weld of a ground electrode to a metal shell;

FIG. 7(b) is a plan view of FIG. 7(a);

FIG. 7(c) is a sectional view taken along the line E-E in FIG. 7(b);

FIG. 8 is a graph which shows relations between the melt depth of a weld of a ground electrode to the metal shell and joint strength;

FIG. 9(a) is a partially enlarged sectional view which shows a spark plug according to the second embodiment of the invention;

FIG. 9(b) is a plan view of FIG. 9(a);

FIG. 9(c) is a sectional view taken along the line H-H in FIG. 9(b);

FIG. 10(a) is a partially sectional view which shows a weld of a ground electrode and a metal shell of a spark plug according to the third embodiment of the invention;

FIG. 10(b) is a plan view of FIG. 10(a);

FIG. 11(a) is a partially sectional view for explaining a ground electrode welding manner in a spark plug according to the fourth embodiment of the invention;

FIG. 11(b) is a plan view of FIG. 11(a);

FIG. 12(a) is a plan view which shows a first modification of a spark plug;

FIG. 12(b) is a partially sectional view of FIG. 12(a);

FIG. 12(c) is a plan view which shows a second modification of a spark plug;

FIG. 12(d) is a partially sectional view of FIG. 12(c);

FIG. 12(e) is a plan view which shows a third modification of a spark plug;

FIG. 12(f) is a partially sectional view of FIG. 12(e);

FIG. 13(a) is a partially plan view of a first modification of a weld of a ground electrode to a metal shell of a spark plug;

FIG. 13(b) is a partially sectional view of FIG. 13(a);

FIG. 13(c) is a partially plan view of a second modification of a weld of a ground electrode to a metal shell of a spark plug;

FIG. 13(d) is a partially sectional view of FIG. 13(c);

FIG. 14(a) is a partially enlarged sectional view which shows a joint of a ground electrode to a metal shell of a comparative spark plug;

FIG. 14(b) is a plan view of FIG. 14(a); and

FIG. 14(c) is a sectional view taken along the line A-A in FIG. 14(b).

### DESCRIPTION OF THE PREFERRED EMBODIMENTS

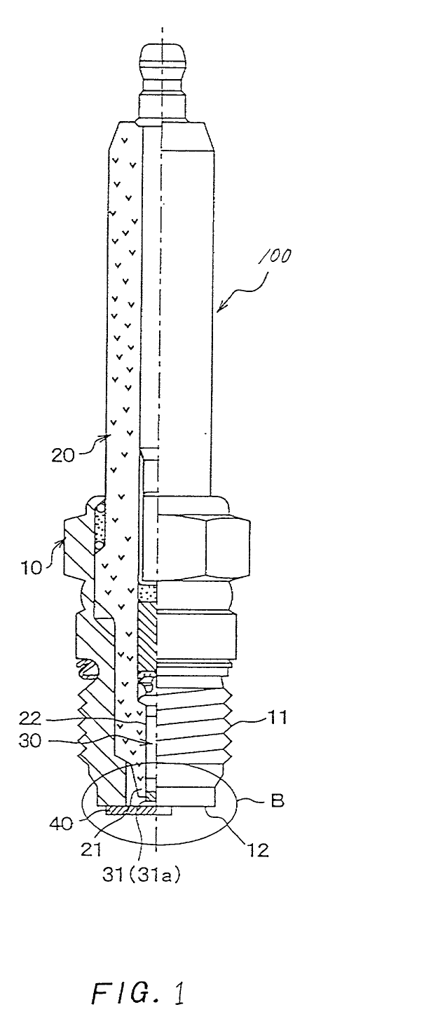

Referring to the drawings, wherein like reference numbers refer to like parts in several views, particularly to FIG. 1, there is shown a spark plug 100 which may be used in a gas engine of a generator in a cogeneration system.

The spark plug 100 includes a cylindrical metal shell (housing) 10, a porcelain insulator 20, a center electrode 30, and a ground electrode 40. The metal shell 10 has cut therein a thread 11 for mounting the spark plug 100 in an engine block (not shown). The porcelain insulator 20 made of an alumina ceramic (Al₂O₃) is retained within the metal shell 10 and has a tip 21 exposed inside the metal shell 10.

The metal shell 10 is made of an Fe-based alloy such as a carbon steel. It is advisable that the Fe-based alloy contain at least one of 0.15% by weight or less of S, 0.35% by weight or less of Si, 0.25% by weight or less of C, 1.5% by weight or less of Mn, and 0.1% by weight or less of P.

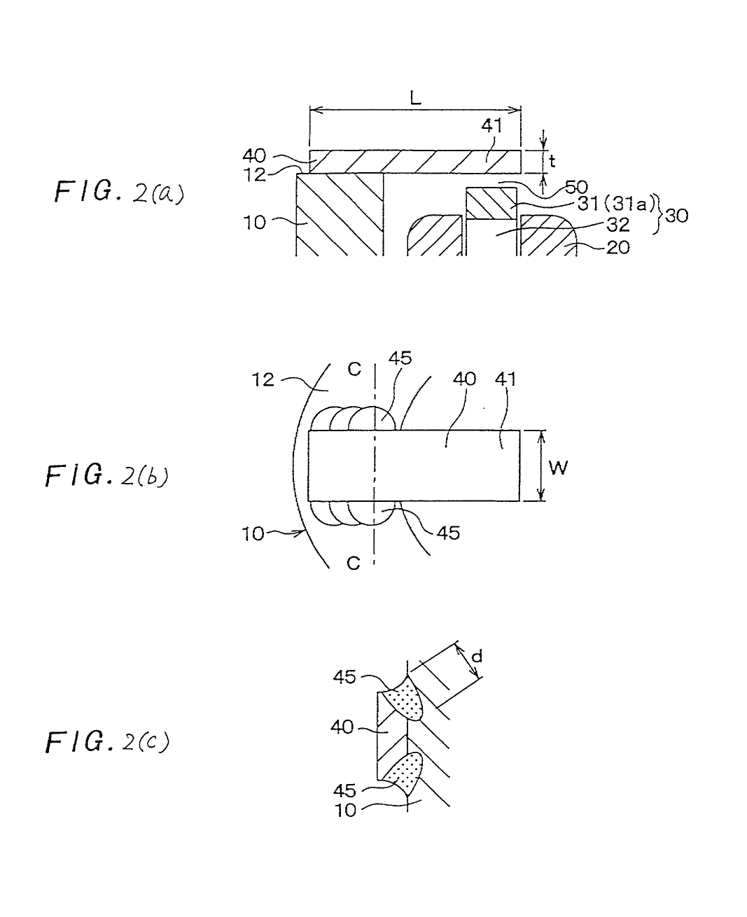

The center electrode 30 is secured in a central chamber 22 of the porcelain insulator 20 and insulated electrically from the metal shell 10. The center electrode 30 has a tip 31 projecting from the tip 21 of the porcelain insulator 20. The center electrode 30, as shown in FIG. 2(a), consists of a body 32 and an Ir alloy chip 31a. The body 32 is made of a cylindrical member which consists of a core portion made of a metallic material such as Cu having a higher thermal conductivity and an external portion made of a metallic material such as an Ni-based alloy having higher thermal and corrosion resistances. The Ir alloy chip 31a is of a disc shape and welded to an end of the body 32 to define the tip 31.

The ground electrode 40 is made of an Ir alloy bar as a whole and connected directly to the end 12 of the metal shell 10 by the laser or arc welding. The ground electrode 40, as clearly shown in FIGS. 2(a) and 2(b), extends horizontally over the center electrode 30 and defines a spark gap 50 between an end 41 thereof and the tip 31 of the center electrode 30. In the illustrated example, the ground electrode 40 is of a square pole shape and installed on the end 12 of the metal shell 10 on a side of the tip 31 of the center electrode 30. FIGS. 2(a) to 2(c) illustrate for the case where the ground electrode 40 is joined to the metal shell 10 by means of the laser welding.

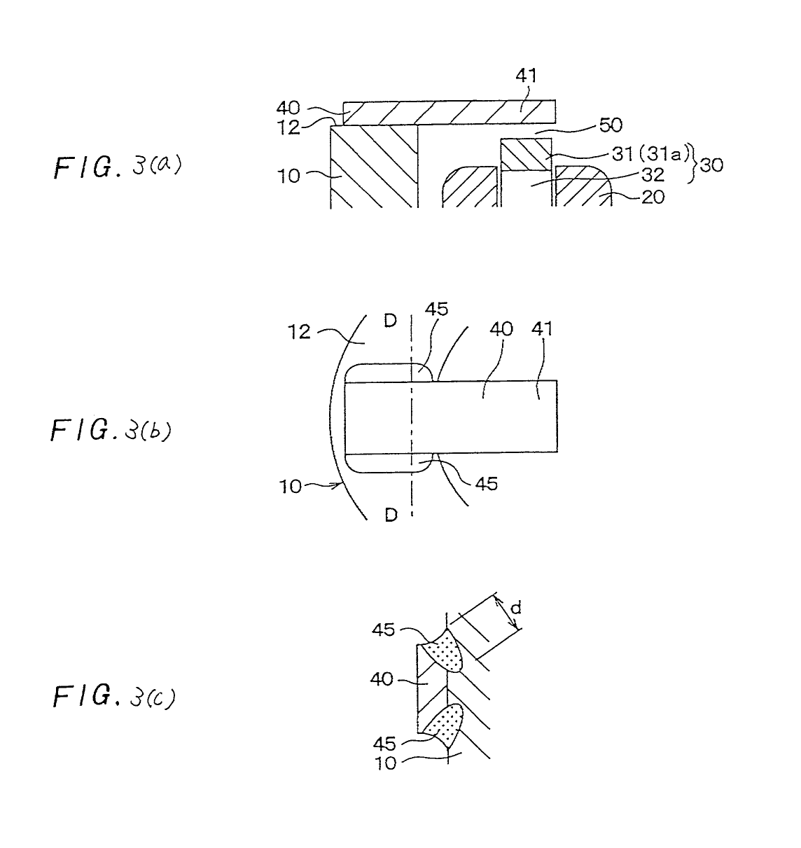

FIGS. 3(a), 3(b), and 3(c) illustrate the ground electrode 40 which is joined to the end 12 of the metal shell 10 by means of the arc welding. The laser welding, as shown in FIGS. 2(a) to 2(c), is different from the arc welding, as shown in FIGS. 3(a) to 3(c), in shape of the whole of a joint of the ground electrode 40 and the end 12 of the metal shell 10. Specifically, the joint of the ground electrode 12 and the metal shell 10 provided by the laser welding is formed by a series of fused portions 45, as clearly shown in FIG. 2(b), in which materials of the ground electrode 40 and the metal shell 10 are melted together by a sequence of laser radiations, while the joint provided by the arc welding is formed by a single fused portion 45, as clearly shown in FIG. 3(b), in which the materials of the ground electrode 40 and the metal shell 10 are melted together by an electric arc radiated to the whole of a desired welding area. It is preferable that the melt depth d of each fused portion 45 in the examples of FIGS. 2(a) to (c) and FIGS. 3(a) to 3(c) be within a range of 0.3 mm to 1.5 mm.

The Ir alloy chip 31a installed on the end of the center electrode 30 and the ground electrode 40 are preferably made of an Ir alloy containing 50 Wt % or more of Iridium (Ir). For example, a material containing a main component of more than 50 Wt % of Ir and an additive of at least one of Rh (rhodium), Pt (platinum), Os (osmium), Ni, Ru (ruthenium), Pd (palladium), and W (tungsten) (referred to as an Ir-10Rh below). In this embodiment, the Ir alloy chips 31a and the ground electrode 40 is each made of material containing 90 Wt % of Ir and 10 Wt % of Rh. The Ir alloy chip 31a is made of a disc having a diameter of 2.4 mm and a thickness of 1.4 mm. The ground electrode 40 is made of a plate which is 2.5 mm wide, 9.0 mm long, and 1.0 mm thick.

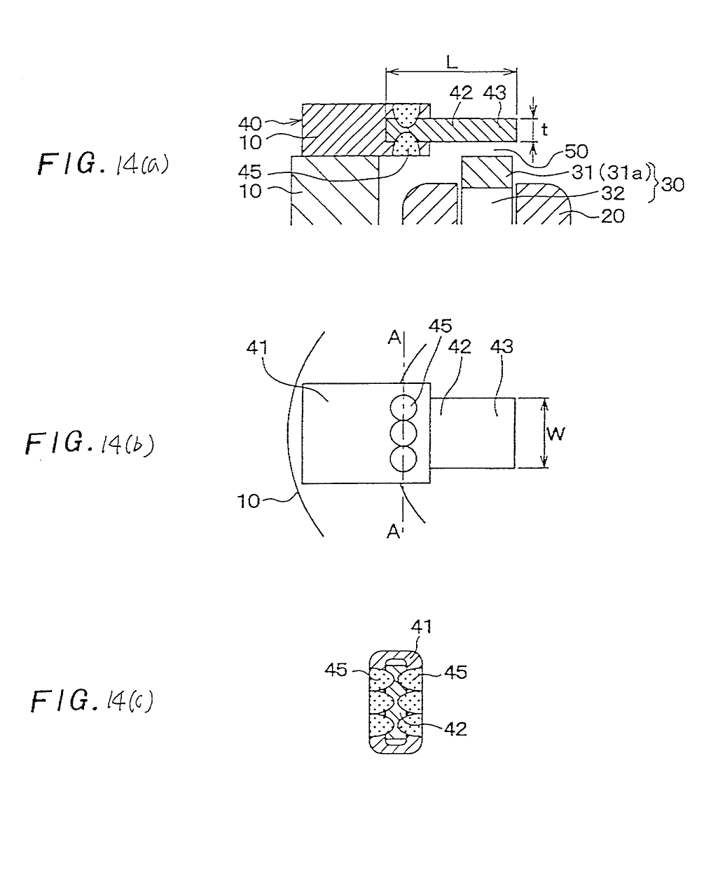

The whole of the ground electrode 40 is, as described above, made of an Ir alloy, thus resulting in an improved wear resistance thereof. The ground electrode 40 is joined directly to the metal shell 10. The weld of the ground electrode 40 to the metal shell 10, that is, the fused portion(s) 45 is, thus, located far from the end 41 of the ground electrode 40 subjected to the intense heat, thereby avoiding an undesirable rise in temperature of the fused portion(s) 45. Further, the ground electrode 40 is welded to the metal shell 10 at a single location, so that the number of welds is decreased as compared with the structure, as shown in FIGS. 14(a) to 14(c), thereby resulting in improved thermal conductivity of the whole of the ground electrode 40 to hold a rise in temperature of the ground electrode 40 low. This improves the wear resistance of the ground electrode 40, thereby increasing the service life of the spark plug 100.

We performed durability tests on samples of the spark plug 100 in this embodiment (will also referred to as embodiment samples below) and samples of the comparative spark plug as shown in FIGS. 14(a) to 14(c) (will also referred to as comparative samples below). Each sample was installed in a cogeneration engine. The engine was run at 1600 rpm. (full speed). After the durability tests, the service life of each sample was determined as a function of an increase in spark gap 50.

The ground electrode 40 of each embodiment sample used in the durability tests was made of an Ir-10Rh plate which was 2.5 mm wide, 9.0 mm long, and 1.0 mm thick. The ground electrode 40 was laser-welded to the metal shell 10. The melt depth d of the fused portions 45, as shown in FIG. 2(c), was between 0.3 mm and 1.5 mm. Similarly, the Ir alloy chip 31a was made of the Ir-10Rh and has a diameter of 2.4 mm and a thickness of 1.4 mm.

Each comparative sample of the spark plug of FIGS. 14(a) to 14(c) had the base member 41 made of Inconel (trade mark). The base member 41 was joined to the metal shell 10 by the resistance welding. The Ir alloy chip 42 was 2.5 mm wide, 5.0 mm long, and 1.0 mm thick and joined to the base member 41 by the laser welding. The Ir alloy chip 31a was the same as that in this embodiment.

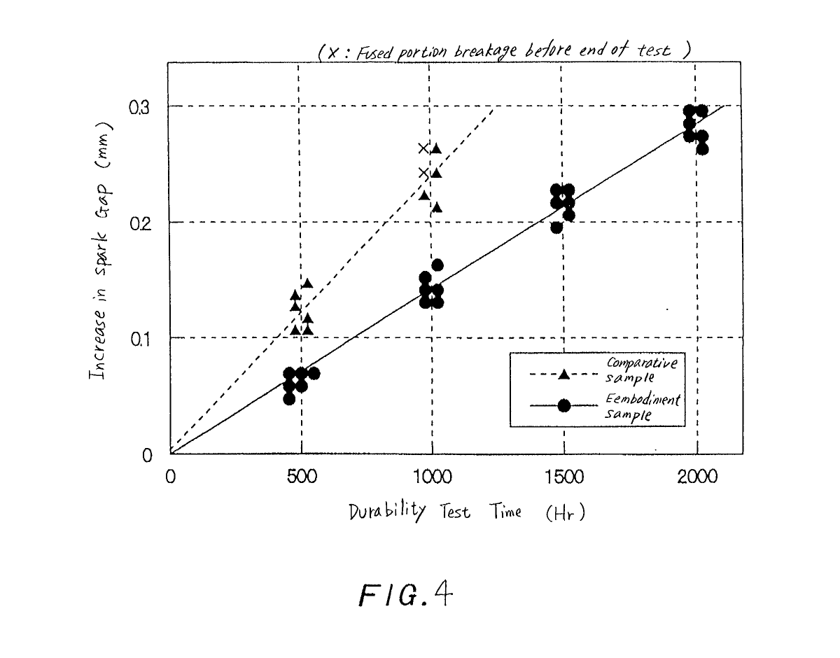

We performed the durability tests on the six embodiment samples and the six comparative samples and researched a relation between a durability test time (Hr) and an increase in the spark gap 50 in each sample. The researched relations are shown in FIG. 4. The temperature of the end 41 of the ground electrode 40 of each embodiment sample was 930°, while the temperature of the end 43 of the ground electrode 40 of each comparative sample was 1020°.

FIG. 4 shows that two of the comparative samples, as indicated by crosses, were broken in the joint of the base member 41 and the Ir alloy chip 42 within 1000 hours, and the other samples, as indicated by black triangles, expired in service life thereof after about 1200 hours due to a rise in required voltage resulting from an increase in spark gap 50 and that lifespans of all the embodiment samples, as indicated by black circles, were longer than those of the comparative samples by approximately 60% (about 2000 Hrs). This is because the ground electrode 40 of each comparative sample has many welded portions, thus resulting in a decrease in thermal conductivity, so that the temperature of the top of the ground electrode 40 is increased to promote the wear of the ground electrode 40, while the ground electrode 40 of each embodiment sample has less welded portions, thereby minimizing a rise in temperature of the top of the ground electrode 40 to decrease the degree of the wear and is higher in reliability of joining to the metal shell 10. Note that the service life of spark plugs is typically a span until a spark gas is increased up to about 0.3 mm.

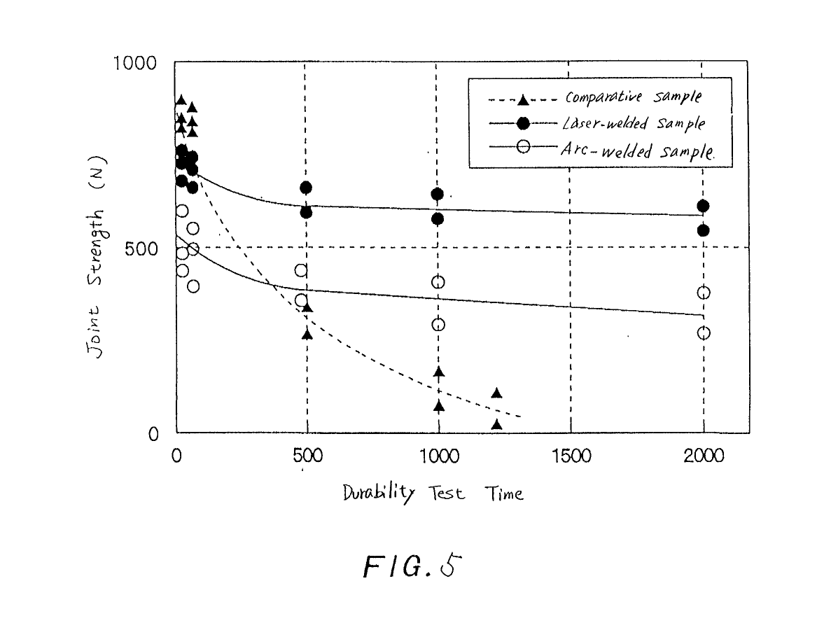

We also performed similar durability tests on samples of the spark plug 100 in which the ground electrode 40 is, as shown in FIGS. 2(a) to 2(c), joined to the metal shell 10 by the laser welding (which will be referred to as laser-welded samples below), samples of the spark plug 100 in which the ground electrode 40 is, as shown in FIGS. 3(a) to 3(c), joined to the metal shell 10 by the arc welding (which will be referred to as arc-welded samples below), and comparative samples of the spark plug, as shown in FIGS. 14(a) to 14(c), and evaluated the reliability of joining of the Ir alloy as a function of a tensile strength. Specifically, we measured the tensile strength of a joint of the ground electrode 40 to the metal shell 10 in each of the laser-welded samples and the arc-welded samples and the tensile strength of a joint of the Ir alloy chip 42 to the base member 41 in each of the comparative samples. The material and size of each sample are the same as those in the durability tests in FIG. 4. The results of the tests are expressed in a graph of FIG. 5.

FIG. 5 represents a relation between a durability test time (Hr) and a joint strength (N) in each sample. The melt depth d of the fused portion(s) 45, as shown in FIGS. 2(c) and 3(c), is 1.0 mm. The temperature of the joint of the Ir alloy in each of the laser- and arc-welded samples is 560°, and that in each comparative sample is 870°.

The graph shows that the joint strength of the comparative samples, as indicated by black triangles, drops considerably due to vibration, thermal stress, and oxidation of a joint surface, while the joint strength of the laser-welded samples, as indicated by black circles, and arc-welded samples, as indicated by white circles, is lower than that of the comparative samples at an initial stage of the durability tests, but kept at a serviceable level until 2000 Hrs. This is because the joint of the Ir alloy in the comparative samples is close to the top of the ground electrode 40 exposed to the highest temperature, while the joint of the Ir alloy in the laser- and arc-welded samples is far from the top of the ground electrode 40, so that a rise in temperature of the joint of the Ir alloy, that is, the joint of the ground electrode 40 to the metal shell 10 is lower than that of the comparative samples, thus decreasing the thermal stress acting on the joint to reduce the oxidation of the joint surface.

The graph of FIG. 5 also shows that the laser-welded samples, as indicated by the black circles, are kept in the joint strength higher than the arc-welded samples, as indicated by the white circles. It is, thus, advisable that the ground electrode 40 be connected to the metal shell 10 by means of the laser welding.

The laser welding is micro spot welding which radiates energy higher than that in the arc-welding in a short time. The use of the laser welding to join the Ir alloy having a relatively higher melting point, thus, ensures a desired strength of the joint of the Ir alloy. The laser and arc welding does not involve a pressing operation as required in the resistance welding, thus allowing the spark gap 50 to be adjusted easily during the welding using a spacer without applying an unwanted load on the Ir alloy and its weld. This eliminates the need for a gap adjustment process after the welding which is essential to the conventional spark plugs.

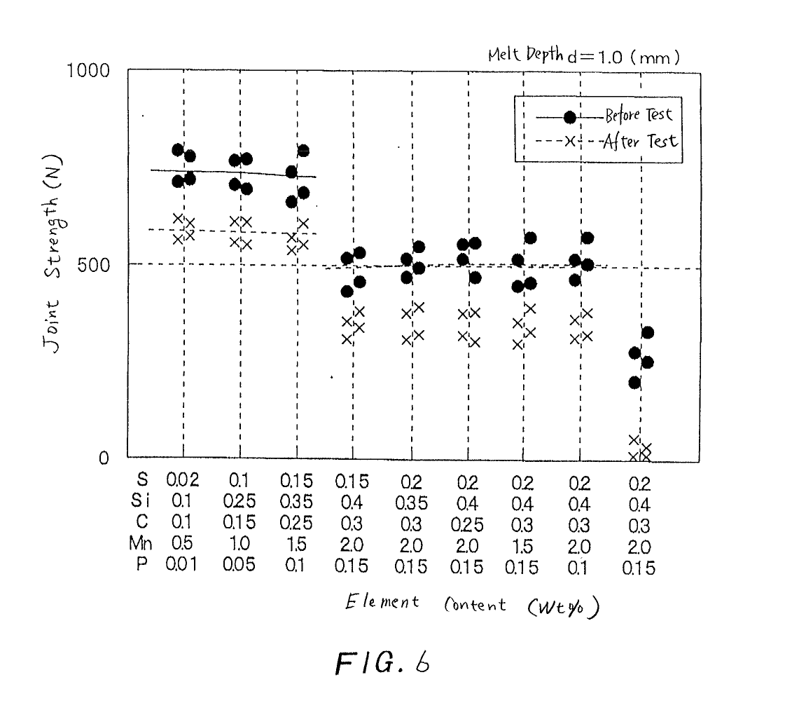

We also evaluated the reliability of the joint of the ground electrode 40 and the metal shell 10 in terms of contents of elements: S, Si, C, Mn, and P in an Fe-based alloy that is the material of the ground electrode 40. The evaluation was achieved, similar to the durability tests in FIG. 5, by measuring the tensile strength of the joint in samples after the samples were placed in the same durability conditions as those in FIG. 5 for 2000 Hrs. The results of the tests are shown in a graph of FIG. 6.

The graph of FIG. 6 represents a relation between an element content (Wt %) and a joint strength (N) in each sample. The melt depth d of the fused portion(s) 45, as shown in FIGS. 2(c) and 3(c), is 1.0 mm. Each black circle denotes the joint strength of the sample before the durability test, and each white circuit denotes the joint strength of the sample after the durability test.

FIG. 6 shows that the Fe-based alloy that is the material of the ground electrode 40 preferably contains 0.15 Wt % or less of S, 0.35 Wt % or less of Si, 0.25 Wt % or less of C, 1.5 Wt % or less of Mn, and 0.1 Wt % or less of P in order to ensure a desired reliability level of the joint of the ground electrode 40 to the metal shell 10 and that when the contents of S, Si, C, Mn, and P all exceed the above ranges, it will cause the joint strength of each sample to be reduced greatly before the durability test, thus making it difficult to ensure the desired reliability level of the joint strength 2000 Hrs after the test is started. We researched the cause using one of the samples containing 0.2 Wt % of S, 0.4 wt % of Si, 0.3 Wt % of C, 2.0 Wt % of Mn, and 0.15 Wt % of P and found that a solidification-caused breakage occurred in the weld of the ground electrode 40 to the metal shell 10 during the welding operation, thus resulting in a decrease in joint strength of the sample before the durability test.

It is, as described above, advisable that the melt depth d of each fused portion 45 of the laser-weld between the ground electrode 40 and the metal shell 10 in FIGS. 2(a) to (c) be within a range of 0.3 mm to 1.5 mm. The reason for this will be discussed below.

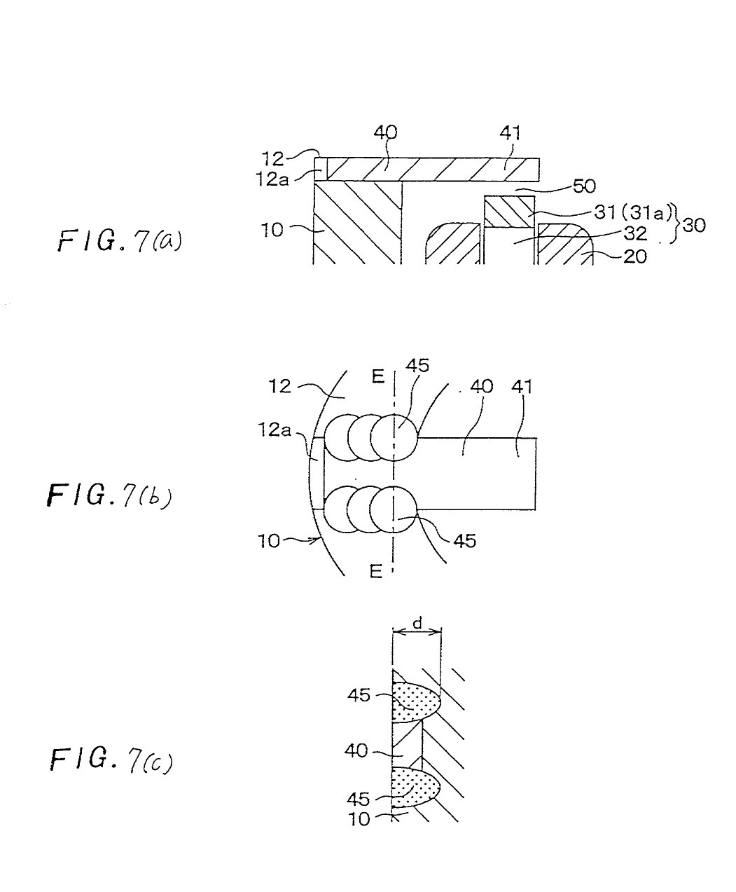

We prepared samples of the spark plug 100, as shown in FIGS. 2(a) to 2(c), which will be referred to as first laser-welded samples below and samples of a spark plug, as shown in FIGS. 7(a) to 7(c), which will be referred to as second laser-welded samples below and evaluated the melt depth d of the fused portions 45. In each of the first laser-welded samples, the ground electrode 40 was put on the flat surface of the end 12 of the metal shell 10, after which laser beams were radiated diagonally to the surface of the end 12 to form the fused portions 45. In each of the second laser-welded samples, the ground electrode 40 was fitted in a recess 12a formed in the end 12 of the metal shell 10 to a depth equivalent to the thickness of the ground electrode 40, after which laser beams were radiated to a boundary of a side wall of the recess 12a and the ground electrode 40 from a direction perpendicular to the surface of the end 12 of the metal shell 10 to form the fused portions 45.

We performed the durability tests, similar to the above, on the first and second laser-welded samples for different values of the melt depth d and measured the joint strength of the Ir alloy in each sample as a function of the tensile strength before and after the 2000 Hr-durability test. Note that the metal shell 10 of each sample is made of an Fe-based alloy containing a combination of 0.15 Wt % of S, 0.35 wt % of Si, 0.25 Wt % of C, 1.5 Wt % of Mn, and 0.1 Wt % of P which has the lowest joint strength within the desired combinations shown in FIG. 6.

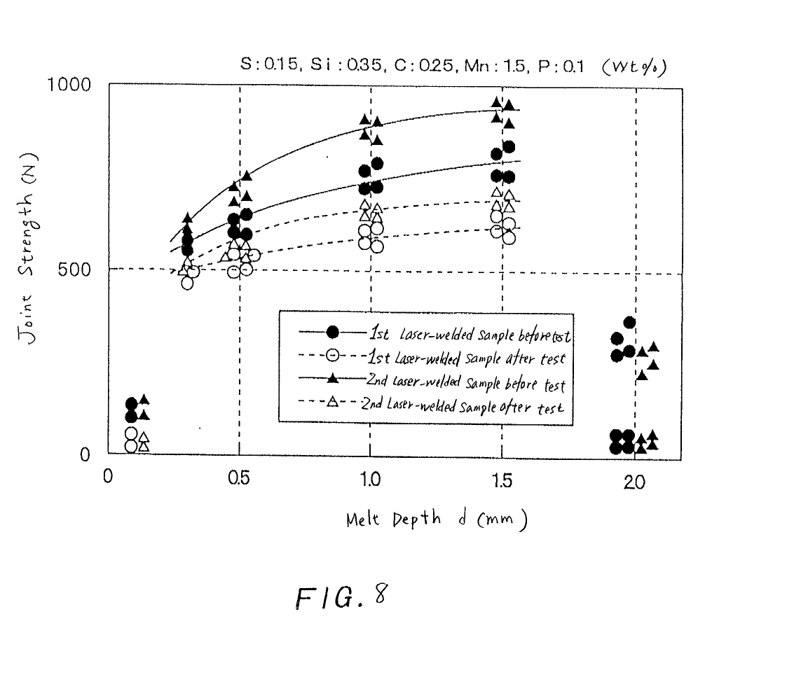

FIG. 8 represents a relation between the melt depth d (mm) and the joint strength of each of the first and second laser-welded samples. Black and white plots denote the first laser-welded samples before and after the durability tests, respectively. Black and white triangular plots denote the second laser-welded samples before and after the durability tests, respectively.

FIG. 8 shows that a serviceable strength of the joint of the ground electrode 40 to the metal shell 10 is obtained when the melt depth d is within a range of 0.3 mm to 1.5 mm regardless of the structure of the fused portions 45 and that when the melt depth d is smaller than 0.3 mm, the joint strength of each sample will be weak before the durability test, and when the melt depth d is greater than 1.5 mm, it will cause the solidification-caused breakage to occur during the welding of the ground electrode 40 to the metal shell 10.

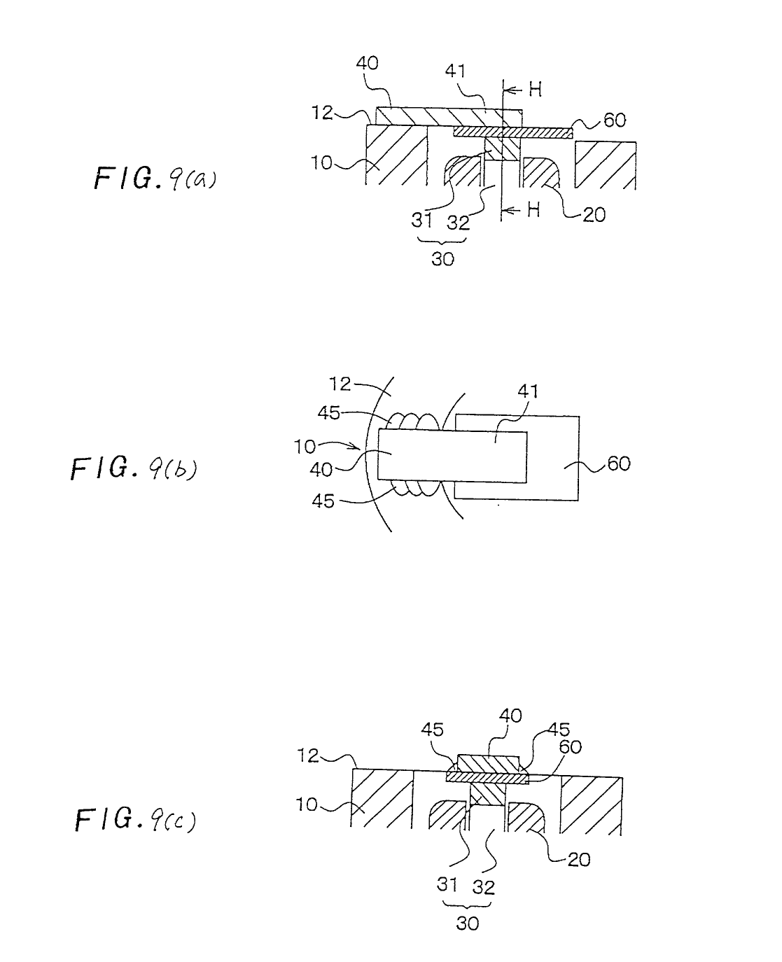

FIGS. 9(a), 9(b), and 9(c) show a spark plug according to the second embodiment of the invention which is different from the first embodiment only in a method of joining the ground electrode 40 to the metal shell 10. Other arrangements are identical, and explanation thereof in detail will be omitted here.

Specifically, a spacer 60 whose thickness is substantially equal to a desired value of the spark gap 50 is first placed between the center electrode 30 and the ground electrode 40. Next, the ground electrode 40 is joined to the metal shell 10 by means of the laser welding or the arc welding. Finally, the spacer 60 is removed.

As described above, if the ground electrode 40 is joined to the metal shell 10 by the resistance welding with the spacer 60 disposed between the center electrode 30 and the ground electrode 40, it may cause the ground electrode 40 to be deformed or broken due to application of the pressure during the welding. The laser and arc welding used in this embodiment, however, does not involve a pressing operation as required in the resistance welding, thus enabling the ground electrode 40 to be welded to the metal shell 10 without the deformation and breakage. If the thickness of the spacer 60 is set equal to a desired value of the spark gap 50, it eliminates the need for a gap adjustment process after the welding which is essential to the conventional spark plugs.

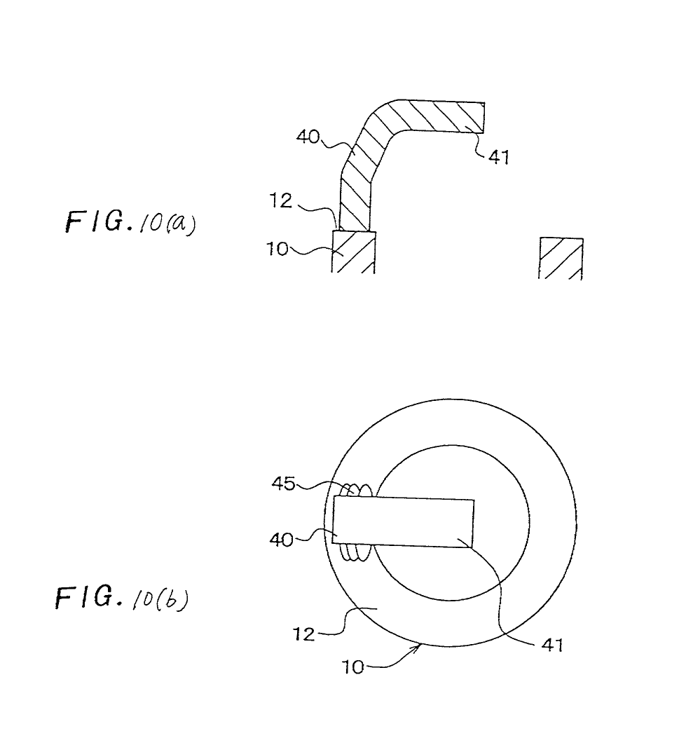

FIGS. 10(a) and 10(b) show a spark plug according to the third embodiment of the invention which is different from the above embodiment in which the ground electrode 40 which is bent to an L-shaped is joined to the metal shell 10 by the laser or ac welding. Other arrangements are identical, and explanation thereof in detail will be omitted here.

In general, it is difficult to weld a bent member. Thus, when it is required to join the ground electrode 40 to the metal shell 10 by the resistance welding, the ground electrode 40 that has a straight length needs to be welded to the metal shell 10, after which the ground electrode 40 is bent until a desired value of the spark gap 50 is reached. However, if the ground electrode 40 is made of a hard member, a high pressure is required to bent the ground electrode 40 after welded to the metal shell 10. The high pressure, therefore, acts on a weld of the ground electrode 40 to the metal shell 10, which may result in breakage of the weld.

It is generally possible for the laser and arc welding to weld a bent member. This embodiment, thus, uses the laser or arc welding to joint the ground electrode 40 which is bent to a desired angle to the metal shell 10.

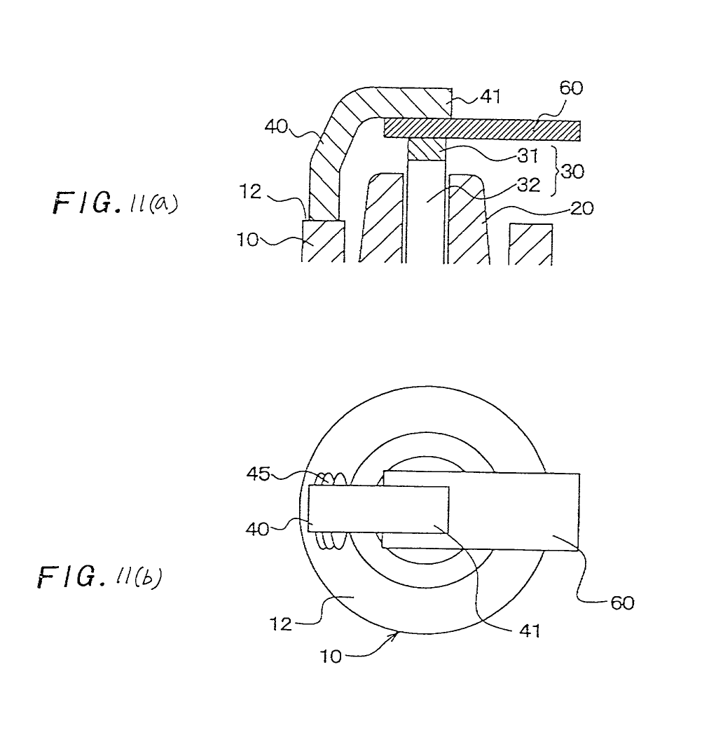

FIGS. 11(a) and 11(b) show a spark plug according to the fourth embodiment of the invention which is different from the third embodiment only in a method of joining the ground electrode 40 to the metal shell 10. Other arrangements are identical, and explanation thereof in detail will be omitted here.

Specifically, after the center electrode 30 is retained within the metal shell 10, a spacer 60 is placed between the center electrode 30 and the ground electrode 40. Next, the ground electrode 40 is joined to the end 12 of the metal shell 10 by means of the laser welding or the arc welding. Finally, the spacer 60 is removed. If the thickness of the spacer 60 is set equal to a desired value of the spark gap 50, it eliminates the need for a gap adjustment process after the welding which is essential to the conventional spark plugs.

In the above embodiments, the tip 31 of the center electrode 30 and the ground electrode 40 are, as described above, both made of an Ir alloy, but may alternatively be made of a Pt alloy containing 50 Wt % or more of Pt which is excellent in wear resistance. It is advisable that the Pt alloy contain a main component of 50 Wt % or more of Pt and an additive of at least one of Ir, Os, Ni, W, Pd, and Ru.

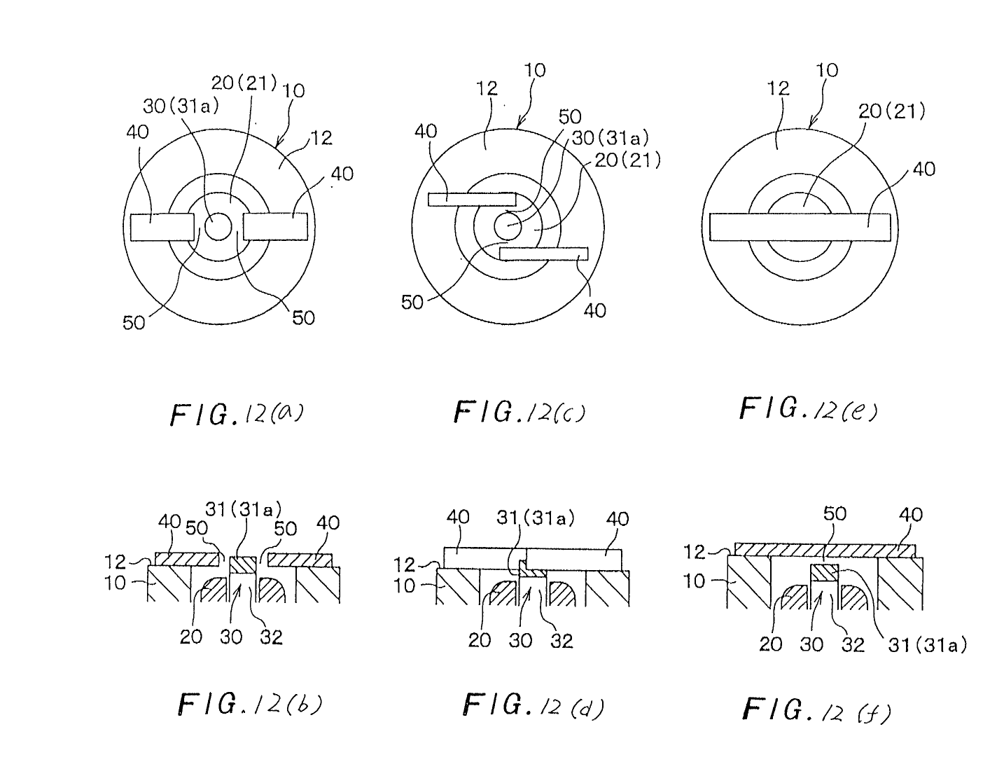

FIGS. 12(a) to 12(f) show different types of spark plugs with which the above described structure of the weld between the ground electrode 40 and the metal shell 10 may be used.

FIGS. 12(a) to 12(d) illustrate dual ground electrode spark plugs each having two ground electrodes 40. More than three ground electrodes 40 may alternatively be employed. Each of the ground electrodes 40 may be made of the same material as that used in the above embodiments.

FIGS. 12(e) and 12(f) illustrate a spark plug with a single ground electrode 40 extending across the tip 31 of the center electrode 30 to define the spark gap 50. The ground electrode 40 may be made of the same material as that used in the above embodiment.

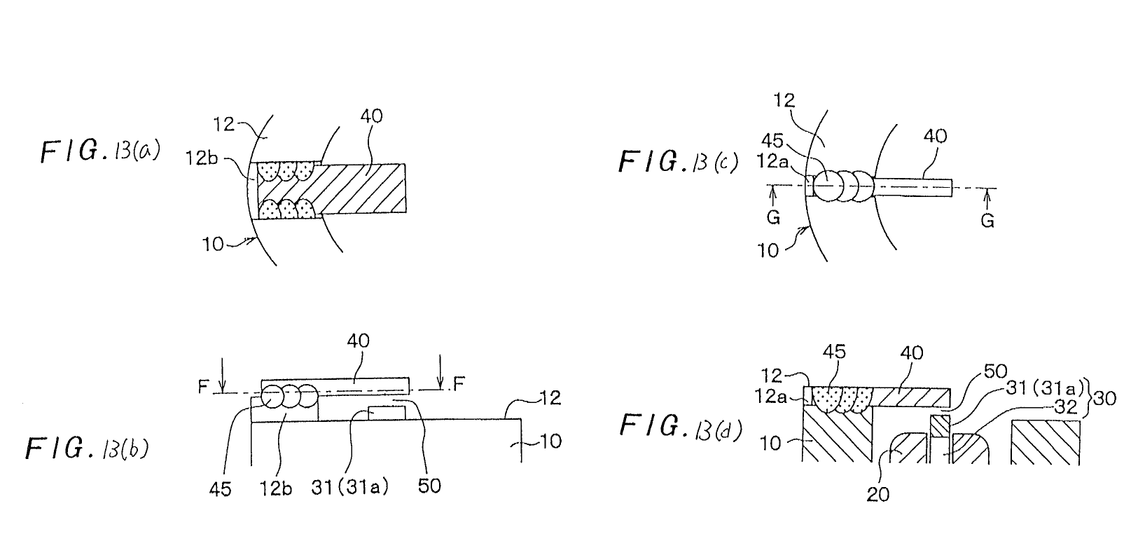

FIGS. 13(a) to 13(d) illustrate spark plugs which are different from the ones in the above embodiments in a structure of the weld of the ground electrode 40 to the metal shell 10.

The spark plug of FIGS. 13(a) and 13(b) has formed on the end 12 of the metal shell 10 a protrusion 12b to which the ground electrode 40 is welded. FIG. 13(a) is a sectional view taken along the line F-Fin FIG. 13(b).

The spark plug of FIGS. 13(c) and 13(d) has formed in the end 12 of the metal shell 10 a recess or groove 12a in which the bar-shaped ground electrode 40 is fitted and welded by radiating laser beams onto an upper surface of the ground electrode 40 to form the fused portions 45. FIG. 13(d) is a sectional view taken along the line G-G in FIG. 13(c).

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A spark plug comprising:
a metal shell;
a center electrode retained in said metal shell to be insulated from said metal shell; and
a ground electrode opposed to said center electrode to define a spark gap between said ground electrode and said center electrode, said ground electrode being joined to said metal shell by one of laser welding and arc welding.

2. A spark plug as set forth in claim 1, wherein the whole of said ground electrode is made of an Iridium alloy and welded at an end thereof directly to said metal shell.

3. A spark plug as set forth in claim 1, wherein a depth of a weld between said ground electrode and said metal shell lies within a range of 0.3 mm to 1.5 mm.

4. A spark plug as set forth in claim 1, wherein said metal shell is made of an Fe-base alloy containing one of 0.15% by weight or less of S, 0.35% by weight or less of Si, 0.25% by weight or less of C, 1.5% by weight or less of Mn, and 0.1% by weight or less of P.

5. A spark plug as set forth in claim 1, wherein said metal shell is made of an Fe-base alloy containing 0.15% by weight or less of S, 0.35% by weight or less of Si, 0.25% by weight or less of C, 1.5% by weight or less of Mn, and 0.1% by weight or less of P.

6. A spark plug as set forth in claim 1, wherein said ground electrode is made of an alloy containing a main component of 50 Wt % or more of Pt and an additive of at least one of Rh, Ir, Os, Ni, W, Pd, and Ru.

7. A spark plug as set forth in claim 1, wherein said ground electrode is made of an alloy containing a main component of 50 Wt % or more of Ir and an additive of at least one of Rh, Pt, Os, Ni, W, Pd, and Ru.

8. A spark plug comprising:
a metal shell;
a center electrode retained in said metal shell to be insulated from said metal shell; and
a ground electrode opposed to said center electrode to define a spark gap between said ground electrode and said center electrode, said ground electrode being all made of an Iridium alloy and joined directly to said metal shell.

9. A spark plug as set forth in claim 8, wherein said ground electrode is joined to said metal shell by laser welding.

10. A spark plug as set forth in claim 9, wherein a depth of a weld between said ground electrode and said metal shell lies within a range of 0.3 mm to 1.5 mm.

11. A spark plug as set forth in claim 8, wherein said metal shell is made of an Fe-base alloy containing one of 0.15% by weight or less of S, 0.35% by weight or less of Si, 0.25% by weight or less of C, 1.5% by weight or less of Mn, and 0.1% by weight or less of P.

12. A spark plug as set forth in claim 8, wherein said metal shell is made of an Fe-base alloy containing 0.15% by weight or less of S, 0.35% by weight or less of Si, 0.25% by weight or less of C, 1.5% by weight or less of Mn, and 0.1% by weight or less of P.

13. A spark plug as set forth in claim 8, wherein said ground electrode is made of an alloy containing a main component of 50 Wt % or more of Ir and an additive of at least one of Rh, Pt, Os, Ni, W, Pd, and Ru.

14. A method of producing a spark plug comprising the step of:
preparing a metal shell;
installing a center electrode in said metal shell to be insulated from said metal shell;
placing a ground electrode so as to be opposed to said center electrode through a spacer having a thickness substantially equal to a desired spark gap to be defined between said ground electrode and said center electrode; and
joining said ground electrode to said metal shell by one of laser welding and arc welding.
